(19) United States
(12) Patent Application Publication
(10) Pub. No.: US 2005/0196552 A1
(43) Pub. Date: Sep. 8, 2005

(54) Anti-reflective optical film for display devices

(76) Inventors: Maria J. Lehmann, Spencerport, NY (US); Timothy C. Schunk, Livonia, NY (US); Jeanne E. Kaeding, Rochester, NY (US); Dennis E. Smith, Rochester, NY (US); Roland J. Koestner, Penfield, NY (US); Sherry L. Rock, Hilton, NY (US)

Correspondence Address: Paul A. Leipold;Patent Legal Staff, Eastman Kodak Company, 343 State Street, Rochester, NY, 14650-2201, US

(21) Appl. No.: 11/101,004

(22) Filed: Apr. 7, 2005

Related U.S. Application Data
(63) Continuation-in-part of application No. 10/715,655, filed on Nov. 18, 2003, now abandoned.

(51) Int. Cl. C09K 19/00

(52) U.S. Cl. 428/1.1

(57) ABSTRACT

The invention provides an optical film comprising a transparent support with an antireflection layer substantially conformed in shape to the surface underlying the layer, the antireflection layer containing a binder polymer having dispersed polymer particles which are nanovoided so as to have a surface area greater than 50 m²/gm and which fill 64% or less of the layer volume. The film provides improved anti-reflection without the expected increase in transmission haze.

### CROSS-REFERENCE TO RELATED APPLICATIONS

This application is a Continuation-in-Part of U.S. application Ser. No. 10/715,655 filed Nov. 18, 2003 which was co-filed with commonly assigned U.S. application Ser. No. 10/715,706 on Nov. 18, 2003

### FIELD OF THE INVENTION

This invention relates to an optical film for use in high definition image display devices such as LCD and CRT panels for imparting excellent viewing quality, in which the film includes certain nanovoided particles which enable the film to exhibit anti-reflection properties.

### BACKGROUND OF THE INVENTION

LCDs and CRTs are widely employed in a variety of typical display devices such as television sets, computer terminals and the like. A key problem is improving the quality of the display devices in keeping with the trend for increased image resolution. With the advent of multimedia including, in particular, a variety of portable terminals of communication systems represented by mobile telephones and the like, innovative display systems are expected to play a very important role in the interface between man and machine. Since these portable terminals are frequently used outdoors, it is important to ensure good visibility of their images even in bright sunlight. In order to accomplish this, an anti-reflection film is preferably provided on the surface of the display for suppressing specular reflection, and often used in combination with an antiglare film, which diffuses external light.

Much of the prior art shows that vapor deposition of metal oxide layers is used for reflection control. The anti-reflection film depends on destructive interference between the light reflected from the two surfaces of the thin film. Let the refractive index of the substrate be n₂, that of the film n₁, and that of the incident medium (which will be air in most cases) n₀. For complete cancellation of the two reflected beams of light that are nearly normal with the thin film, the ratios of the refractive indices at each boundary should be equal
n₁=\sqrt{(n₀n₂)}.

For complete cancellation of the two beams of light near normal incidence through a thick film, the film thickness (d₁) and refractive index (n₁) are chosen to produce an optical thickness that is one quarter wavelength or higher odd multiple (m).

$${n}_{1} d = \frac{m λ}{4} .$$

A monolayer film can reduce the reflection of light at a single wavelength, but more often a multi-layered film comprising several transparent metal oxide layers superimposed on one another is used to reduce reflection over a wide wavelength region. For such a structure, half wavelength layers are alternated with quarter wavelength layers to improve performance. However, formation of this multi-layered film requires a complicated process comprising a number of chemical or physical vapor deposition procedures, which correspond to the number of metal compound layers, having a predetermined refractive index and thickness. Precise control of the thickness of each layer is required for these interference layers. Also note that vapor deposition is often incompatible with plastic substrates due to process conditions, and is difficult to accomplish on a roll-to-roll format causing mass production to be expensive.

In display applications a plastic substrate such as cellulose acetate or poly(ethylene terephthalate) is often used. The refractive index required for a single layer reflection control film to yield zero reflectance at a selected wavelength with a plastic substrate would be in the range of 1.22. Unfortunately, such low refractive index solid materials are not available. Fluorinated polymer (n=1.33-1.39) or inorganic MgF₂ grains (n=1.38) are the commonly used low refractive index materials.

For a particular substrate, the reflectance of a thin layer near normal incidence is written as

$$\% R = 100 {( \frac{{n}_{0} {n}_{2} - {n}_{1}^{2}}{{n}_{0} {n}_{2} + {n}_{1}^{2}} )}^{2}$$

Thus a typical display plastic substrate at n=1.50 with a thin single layer at n=1.35 would yield a minimum reflectance of approximately 1.0%. For a high quality display device however, an anti-reflection film with reflectance significantly below 1% is desired.

Incorporated sub-wavelength voids could produce a refractive index below 1.33 in a thin layer on a plastic substrate. In the simplest model, the volume average dielectric constant (ε≈n²) of air and material may be used to estimate the refractive index of the voided layer. There are many ways to create voided layers, such as embossing, etching, phase separation and interstitial voids between particles. However, these approaches either have delicate surfaces or do not adequately control the void size distribution. Since the anti-reflection film is in direct contact with the user, the film must be as rugged as possible. In addition, transmission haze from poor control of void size distribution must be kept to a minimum for adequate display viewing.

U.S. Pat. No. 6,210,858 and Japanese Patent Provisional Publication No. 11[1999]-326601 describe anti-reflection films comprised of low refractive index layers containing inorganic fine particles. The layer refractive index reduction is largely obtained by interstitial air voids. However, the use of interstitial air voids to reduce refractive index may easily produce a hazy film due to the lack of control of the void size distribution. The use of inorganic particles may also carry a potential chemical instability with manufacturing process solutions commonly used during display fabrication, e.g. saponification and neutralization baths for cellulose triacetate film.

U.S. Pat. No. 5,919,555 and Japanese Patent Provisional Publication No. 10[1998]-142403 describe anti-reflection films comprising low refractive index layers containing sub-micron polymer particles in a binder. The layer refractive index reduction is again largely attained with interstitial air voids. Although these polymeric particles have better chemical stability than inorganic particles, the potential difficulty of size control of the interstitial voids may again give hazy films. Another limitation with this approach occurs with the reduced amount of binder that degrades the mechanical strength of the film.

It is well known in the industry to use aggregated silica particles in coatings for antiglare properties. As an example, U.S. Patent Application Publication 2003/0134086 uses the in situ aggregation of very fine hydrophobicized silica grains to produce a porous aggregates in the antiglare film. These silica aggregates comprise a broad size distribution with a large median effective diameter that results in a significant transmission haze penalty.

It is a problem to be solved to provide a film having an improved anti-reflective property with little or no increase in the transmission haze.

### SUMMARY OF THE INVENTION

The invention provides an optical film comprising a transparent support with an antireflection layer substantially conformed in shape to the surface underlying the layer, the antireflection layer containing a binder polymer having dispersed polymer particles which are nanovoided so as to have a surface area greater than 50 m²/gm and which fill 64% or less of the layer volume. The invention also provides an optical element or display employing the film.

The invention provides a film having an improved anti-reflective property with little or no increase in the transmission haze.

### DETAILED DESCRIPTION OF THE INVENTION

The optical film of the invention comprises a low refractive index layer formed of nanovoided polymeric particles in a polymer binder. As used herein, the particles are termed “nanovoided” because the voids are internal pores of very small particles but the term is not used herein to place a specific limit on the dimensions of the internal pores themselves. The low refractive index of this film is achieved by coating the nanovoided particles in a binder such that the binder does not fill the pores in the particles and air voids are retained. There are several advantages to this approach, including increased chemical and mechanical stability as well as decreased transmission haze. Polymeric particles have increased chemical stability in manufacturing process solutions commonly used in the display fabrication industry, as compared with the typical inorganic particles. The mechanical stability of this film is improved because the air voids are retained within the particles, as opposed to interstitial spaces between particles. The particle loading in the film is in the range of 5 to 64 (vol)%, while the film contains less than 3 (vol)% interstitial voids. Transmission haze is undesirable in an optical film, therefore retaining the air voids within the nanovoided particles and avoiding interstitial air voids provides an advantage over other approaches. Since the air voids are largely retained within the particles, there is adequate control of the void size distribution, which eliminates scattering due to sharp changes in refractive index on the visible light wavelength scale. The nanovoided particles behave as if they had a bulk refractive index, and therefore to avoid internal haze in the film, the particle diameter must be less than 200 nm, typically less than 50 nm. The relationship between the particle's surface (A) area and spherical equivalent diameter (D) is

$$A = 4 {π ( \frac{D}{2} )}^{2}$$

The term nanovoided is defined using the surface area ratio of the measured surface area (A_{BET,m}), to the calculated surface area (A_{calc}). A particle may be considered nanovoided if

$$Surface Area Ratio = ( \frac{{A}_{BET , m}}{{A}_{calc}} ) 〉 1.4$$

Otherwise it is nonporous. The 1.4 ratio allows for the normal interstitial voiding for spherical non-porous particles and the excess is a measure of the internal porosity defined herein as nanovoiding. Suitably the surface area ratio is at least 3.0, and often is at least 5.0.

This type of low refractive index layer may also be used in combination with a high refractive index layer to obtain better reflection control. As the number of layers constituting the anti-reflection film increases, the wavelength region of reflection control is broadened. This is based on the principle of multi-layer anti-reflection films using metal compounds. When a low refractive index layer is formed on top of a higher refractive index layer for a two layer anti-reflection film, the following conditions are generally met:

$$0.7 m ( \frac{λ}{4} ) < {n}_{1} {d}_{1} < 1.3 m ( \frac{λ}{4} )$$

$$0.7 k ( \frac{λ}{4} ) < {n}_{2} {d}_{2} < 1.3 k ( \frac{λ}{4} )$$

in which m represents a positive even integer, n₁ represents the refractive index of the high index layer and d₁ represents the thickness of the high index layer; k represents a positive odd integer, n₂ represents the refractive index of the low index layer and d₂ represents the thickness of the low index layer. These conditions can be expanded to describe anti-reflection films consisting of more than two layers.

The optical film in this invention is used for reflection control, and therefore may be used in combination with other optically functional layers such as a hard-coat/anti-glare layer (HC/AG). An anti-reflection (or low reflection) film reduces the intensity of the reflected light in the specular direction, as opposed to an anti-glare film, which diffuses the reflected light and often contains a hard-coat. The combined effect of specular intensity reduction and diffused reflected image greatly improves the viewing quality of the display.

The particles that are used in this invention are in the form of nanovoided spherical polymer beads or nanovoided irregularly shaped polymer particles. Either particle can also have a smooth or a rough surface. Suitable polymeric particles used in the invention comprise, for example, acrylic resins, styrenic resins, or cellulose derivatives, such as cellulose acetate, cellulose acetate butyrate, cellulose propionate, cellulose acetate propionate, and ethyl cellulose; polyvinyl resins such as polyvinyl chloride, copolymers of vinyl chloride and vinyl acetate and polyvinyl butyral, polyvinyl acetal, ethylene-vinyl acetate copolymers, ethylene-vinyl alcohol copolymers, and ethylene-allyl copolymers such as ethylene-allyl alcohol copolymers, ethylene-allyl acetone copolymers, ethylene-allyl benzene copolymers, ethylene-allyl ether copolymers, ethylene acrylic copolymers and polyoxy-methylene; polycondensation polymers, such as, polyesters, including polyethylene terephthalate, polybutylene terephthalate, polyurethanes and polycarbonates.

In a preferred embodiment of the invention, the nanovoided polymeric particles are made from a styrenic or an acrylic monomer. Any suitable ethylenically unsaturated monomer or mixture of monomers may be used in making such styrenic or acrylic polymer. There may be used, for example, styrenic compounds, such as styrene, vinyl toluene, p-chlorostyrene, vinylbenzylchloride or vinyl naphthalene; or acrylic compounds, such as methyl acrylate, ethyl acrylate, n-butyl acrylate, n-octyl acrylate, 2-chloroethyl acrylate, phenyl acrylate, methyl-α-chloroacrylate, methyl methacrylate, ethyl methacrylate, butyl methacrylate; and mixtures thereof.

The nanovoided polymeric particles are most preferably made from fluorine derivatives of the monomers listed above, such that the refractive index of the particle is further reduced, which reduces the reflectance further.

Typical cross linking monomers used in making the nanovoided polymeric particles used in the invention are aromatic divinyl compounds such as divinylbenzene, divinylnaphthalene or derivatives thereof; diethylene carboxylate esters and amides such as 1,4 butanediol diacrylate, 1,4 butanediol dimethacrylate, 1,3 butylene glycol diacrylate, 1,3 butylene glycol dimethacrylate, cyclohexane dimethanol diacrylate, cyclohexane dimethanol dimethacrylate, diethylene glycol diacrylate, diethylene glycol dimethacrylate, dipropylene glycol diacrylate, dipropylene glycol dimethacrylate, ethylene glycol diacrylate, ethylene glycol dimethacrylate, 1,6 hexanediol diacrylate, 1,6 hexanediol dimethacrylate. neopentyl glycol diacrylate, neopentyl glycol dimethacrylate, tetraethylene glycol diacrylate, tetraethylene glycol dimethacrylate, triethylene glycol diacrylate, triethylene glycol dimethacrylate, tripropylene glycol diacrylate, tripropylene glycol dimethacrylate, pentaerythritol triacrylate, trimethylolpropane triacrylate, trimethylolpropane trimethacrylate, dipentaerythritol pentaacrylate, di-trimethylolpropane tetraacrylate, pentaerythritol tetraacrylate, allyl methacrylate, allyl acrylate, diallylphthalate, diallyl maleate, dienes such as butadiene and isoprene and mixtures thereof, and other divinyl compounds such as divinyl sulfide or divinyl sulfone compounds. Ethylene glycol diacrylate, ethylene glycol dimethacrylate, 1,6 hexanediol diacrylate, 1,6 hexanediol dimethacrylate, and trimethylolpropane triacrylate are preferred. Especially preferred is ethylene glycol dimethacrylate.

The nanovoided polymeric particles have a degree of cross linking of about 50 mole % or greater, preferably about 80 mole %, and most preferably about 100 mole %. The degree of cross linking is determined by the mole % of multifunctional cross linking monomer which is used to make the nanovoided polymeric particles.

The nanovoided polymeric particles used in this invention can be prepared, for example, by pulverizing and then classifying nanovoided organic compounds, by emulsion, suspension, and dispersion polymerization of organic monomers, by spray drying of a solution containing organic compounds, or by a polymer suspension technique which consists of dissolving an organic material in a water immiscible solvent, dispersing the solution as fine liquid droplets in aqueous solution, and removing the solvent by evaporation or other suitable techniques. The bulk, emulsion, dispersion, and suspension polymerization procedures are well known to those skilled in the polymer art and are taught in such textbooks as G. Odian in “Principles of Polymerization”, 2nd Ed. Wiley (1981), and W. P. Sorenson and T. W. Campbell in “Preparation Method of Polymer Chemistry”, 2nd Ed, Wiley (1968).

Techniques to synthesize nanovoided polymer particles are taught, for example, in U.S. Pat. Nos. 5,840,293; 5,993,805; 5,403,870; 5,599,889; and 6,475,602, and Japanese Kokai Hei 5[1993]-222108, the disclosures of which are hereby incorporated by reference. For example, an inert fluid or porogen may be mixed with the monomers used in making the nanovoided polymer particles. After polymerization is complete, the resulting polymeric particles are, at this point, substantially nanovoided because the polymer has formed around the porogen thereby forming the pore network. This technique is described more fully in U.S. Pat. No. 5,840,293 referred to above.

A preferred method of preparing the nanovoided polymeric particles used in this invention includes forming a suspension or dispersion of ethylenically unsaturated monomer droplets containing the cross linking monomer and a porogen in an aqueous medium, polymerizing the monomer to form solid, nanovoided polymeric particles, and optionally removing the porogen by vacuum stripping. Especially preferred is using a surfactant to stabilize the suspension or dispersion.

Surfactants can be anionic, cationic, zwitterionic, neutral, low molecular weight, macromolecular, synthetic, extracted, or derived from natural sources. Some examples include, but are not necessarily limited to: sodium dodecylsulfate, sodium dodecylbenzenesulfonate, sulfosuccinate esters, such as those sold under the AEROSOL® trade name, fluorosurfactants, such as those sold under the ZONYL® and FLUORAD® trade names, ethoxylated alkylphenols, such as TRITON® X-100 and TRITON® X-705, ethoxylated alkylphenol sulfates, such as RHODAPEX® CO-436, phosphate ester surfactants such as GAFAC® RE-90, hexadecyltrimethylammonium bromide, polyoxyethylenated long-chain amines and their quaternized derivatives, ethoxylated silicones, alkanolamine condensates, polyethylene oxide-co-polypropylene oxide block copolymers, such as those sold under the PLURONIC® and TECTRONIC® trade names, N-alkylbetaines, N-alkyl amine oxides, and fluorocarbon-poly(ethylene oxide) block surfactants, such as FLUORAD® FC-430.

The nanovoided particles thus prepared have a porosity as measured by a specific surface area of about 50 m²/g or greater, preferably 200 m²/g or greater. The surface area is usually measured by B.E.T. nitrogen analysis known to those skilled in the art.

The nanovoided polymeric particles used in this invention have a median diameter of less than 200 nm, preferably less than 50 nm. Median diameter is defined as the statistical average of the measured particle size distribution on a volume basis. For further details concerning median diameter measurement, see T. Allen, “Particle Size Measurement”, 4th Ed., Chapman and Hall, (1990).

The anti-reflection layer of the present invention is derived from a high molecular weight binder polymer containing nanovoided polymer particles coated onto a flexible transparent support such that it provides advantageous properties such as good film formation, excellent anti-reflection properties, and low haze. Other desirable features include good fingerprint resistance, abrasion resistance, toughness, hardness and durability.

The binder polymer used in this invention is selected from the group consisting of cellulose triacetate, polyethylene terephthalate, diacetyl cellulose, acetate butyrate cellulose, acetate propionate cellulose, polyethersulfone, poly(meth)acrylic-based resin, polyurethane-based resin, polyester, polycarbonate, aromatic polyamide, polyolefins, polymers derived from vinyl chloride, polyvinyl chloride, polysulfone, polyether, polynorbornene, polymethylpentene, polyether ketone and (meth)acrylonitrile.

In a preferred embodiment of the invention, the binder polymer is selected from an acrylic or methacrylic polymer. The binder polymer is most preferably a fluorine derivative of one of the aforementioned polymers, or mixtures thereof. Selecting a polymer containing fluorine will further reduce the refractive index of the layer, thereby decreasing reflectance further.

The term “high molecular weight” in this invention means that the binder polymer gyration radius is significantly larger than the median pore radius of the nanovoided particles that thereby incorporates air voids of controlled size in the film. The present invention provides an optical film that contains voided particles for use in high definition image display devices such as LCD or CRT panels for imparting excellent anti-reflection properties.

Examples of solvents employable for coating the anti-reflection layer of this invention include solvents such as methanol, ethanol, propanol, butanol, cyclohexane, heptane, toluene and xylene, esters such as methyl acetate, ethyl acetate, propyl acetate and mixtures thereof. With the proper choice of solvent, adhesion between the transparent plastic substrate film and the coating resin can be improved while minimizing migration of plasticizers and other addenda from the transparent plastic substrate film, enabling the optical features of the anti-reflection layer to be maintained. Suitable solvents for supports such as TAC are aromatic hydrocarbon and ester solvents such as toluene and propyl acetate.

The organic solvent fraction is 1-90% percent by weight of the total coating composition. The proper choice of solvents will allow binder solubility and particle dispersion, while avoiding particle swelling and reactivity.

The thickness for a single anti-reflection layer should be under the incident light wavelength, while the individual thicknesses for an anti-reflection multilayer stack should be set to the quarter- or half-wavelength condition as previously described for interference coatings. The anti-reflection layer in accordance with this invention is particularly advantageous due to superior physical properties including pore size control, pore strength, excellent chemical stability, and exceptional transparency provided by low haze.

The anti-reflection layer is preferably colorless. But it is specifically contemplated that this layer can have some color for the purposes of color correction, or for special effects, so long as it does not detrimentally affect the formation or viewing of the display through the overcoat. Thus, dyes can be incorporated into the polymer that will impart color. Further compounds may be added to the optical film composition, depending on the functions of the particular layer, including surfactants, emulsifiers, coating aids, lubricants, matte particles, rheology modifiers, cross linking agents, antifoggants, inorganic fillers such as conductive and nonconductive metal oxide particles, pigments, magnetic particles, biocide, and the like.

The anti-reflection layer of the invention can be applied by any of a number of well known techniques, such as dip coating, rod coating, blade coating, air knife coating, gravure coating and reverse roll coating, slot coating, extrusion coating, slide coating, curtain coating, and the like. After coating, the layer is generally dried by simple evaporation, which may be accelerated by known techniques such as convection heating. Known coating and drying methods are described in further detail in Research Disclosure No. 308119, Published December 1989, pages 1007 to 1008.

The support material for this invention can comprise various transparent polymeric films, such as films derived from triacetyl cellulose (TAC), polyethylene terephthalate (PET), diacetyl cellulose, acetate butyrate cellulose, acetate propionate cellulose, polyether sulfone, polyacrylic based resin (e.g., polymethyl methacrylate), polyurethane based resin, polyester, polycarbonate, aromatic polyamide, polyolefins (eg., polyethylene, polypropylene), polymers derived from vinyl chloride (e.g., polyvinyl chloride and vinyl chloride/vinyl acetate copolymer), polyvinyl alcohol, polysulfone, polyether, polynorbornene, polymethylpentene, polyether ketone, (meth)acrylonitrile, glass and the like. The optical films may vary in thickness from 1 to 50 mils or so.

Although it is desirable that the light transmissivity of these transparent substrates be as high as possible, the light transmissivity determined according to JIS K7105 & ASTM D-1003 using a BYK Gardner Haze-Gard Plus instrument should be at least 80 percent or, preferably at least 90 percent, or most preferably at least 93 percent. When the transparent substrate is used for an antireflection material mounted on a small and lightweight liquid crystal display device, the transparent substrate is preferably a plastic film. While it is a desirable condition that the thickness of the transparent substrate is as thin as possible from the standpoint of decreasing the overall weight, the thickness should be in the range from 1 to 50 mils in consideration of the productivity and other factors of the antireflection material.

Of the transparent support materials TAC, polycarbonate and polyester are preferred due to their overall durability and mechanical strength. Further, TAC is particularly preferable for a liquid crystal display device, since it has sufficiently low birefringence and makes it possible to laminate a antireflection film and a polarizing device to each other and furthermore can provide a display device of excellent display quality using the antireflection film.

The TAC film usable in the invention may be any one known in the art. The weight percent acetyl value of cellulose triacetate, expressed as combined acetic acid, preferably is in the range of 35% to 70%, especially in the range of 55% to 65%. The weight average molecular weight of cellulose acetate preferably is in the range of 70,000 to 200,000, especially 80,000 to 190,000. The polydispersity index (weight average divided by number average molecular weight) of cellulose acetate is in the range of 2 to 7, especially 2.5 to 4. Cellulose acetate may be obtained from cellulose starting materials derived from either wood pulp or cotton linters. Cellulose acetate may be esterified using a fatty acid such as propionic acid or butyric acid so long as the acetyl value satisfies the desired range.

Cellulose acetate film generally contains a plasticizer. Examples of the plasticizers include phosphate esters such as triphenyl phosphate, biphenylyl diphenyl phosphate, tricresyl phosphate, cresyl diphenyl phosphate, octyl diphenyl phosphate, trioctyl phosphate, and tributyl phosphate; and phthalate esters such as diethyl phthalate, dimethoxyethyl phthalate, dimethyl phthalate, dicyclohexyl phthalate, di(methylcyclohexyl) phthalate, and dioctyl phthalate. Preferable examples of glycolic acid esters are triacetin, tributyrin, butyl phthalyl butyl glycolate, ethyl phthalyl ethyl glycolate, and methyl phthalyl ethyl glycolate. Esters of multicarboxylate aromatic compounds, such as trimellitate, pyromellitate, and trimesate ester may be used. In addition, various acetyl, propionyl, or butyryl esters of sugars, such as sorbitol hexaacetate, may be used. Two or more plasticizers shown above may be combined. The plasticizer is preferably contained in the film in an amount of not more than 25 weight %, especially of 5% to 15 weight %. Films prepared from polymers other than cellulose triacetate may also contain appropriately the above plasticizer.

The TAC of the invention may contain particles of an inorganic or organic compound to provide surface lubrication. Examples of the inorganic compound include silicon dioxide, titanium dioxide, aluminum oxide, zirconium oxide, calcium carbonate, talc, clay, calcined kaolin, calcined calcium silicate, hydrate calcium silicate, aluminum silicate, magnesium silicate, and calcium phosphate. Preferred are silicon dioxide, titanium dioxide, and zirconium oxide, and especially silicon dioxide. Examples of the organic compounds (polymer) include silicone resin, fluororesin and acrylic resin. Preferred is acrylic resin.

The TAC film is preferably prepared by utilizing a solvent casting method. In more detail, the solvent casting method comprises the steps of: casting the polymer solution fed from a slit of a solution feeding device (die) on a support and drying the cast layer to form a film. In a large-scale production, the method can be conducted, for example, by the steps of casting a polymer solution (e.g., a dope of cellulose triacetate) on a continuously moving band conveyor (e.g., endless belt) or a continuously rotating drum, and then vaporizing the solvent of the cast layer.

Any support can be employed in the solvent casting method, so long as the support has the property that a film formed thereon can be peeled therefrom. Supports other than metal and glass plates (e.g., plastic film) are employable, so long as the supports have the above property. Any die can be employed, so long as it can feed a solution at a uniform rate. Further, as methods for feeding the solution to the die, a method using a pump to feed the solution at a uniform rate can be employed. In a small-scale production, a die capable of holding the solution in an appropriate amount can be utilized.

A polymer employed in the solvent casting method is required to be capable of dissolving in a solvent. Further a film formed of the polymer is generally required to have high transparency and little optical anisotropy for application in optical products. As the polymer employed in the solvent casting method, preferred is cellulose triacetate. However, other polymers can be employed so long as they satisfy the above conditions.

In the case of employing cellulose triacetate as the polymer, a mixed solvent of dichloromethane and methanol is generally employed. Other solvents such as isopropyl alcohol and n-butyl alcohol can be employed so long as cellulose triacetate is not precipitated. A ratio of cellulose triacetate and solvent in the dope is preferably 10:90 to 30:70 by weight (cellulose triacetate:solvent).

Polycarbonate resin usable in the invention is preferably aromatic carbonates in terms of their chemical and physical properties, and in particular, bisphenol A type polycarbonate is preferred. Among them, bisphenol A type derivatives, in which a benzene ring, cyclohexane ring or aliphatic hydrocarbon group is introduced in the phenol A moiety, are more preferable. In particular, it is preferred that a polycarbonate is obtained by making use of the derivative in which at least one of these groups is introduced asymmetrically with respect to the central carbon atom. For example, a polycarbonate obtained by making use of a carbonate such that two methyl groups attached to the central carbon atom of bisphenol A are replaced by a phenyl group or a hydrogen atom of each benzene ring of bisphenol A is replaced by a substituent such as methyl or phenyl group, asymmetrically with respect to the central carbon atom is preferably used. These can be obtained through a phosgene or transesterification method, from 4,4′-dihydroxy-diphenylalkane or its halogen substituted derivative, such as 4,4′-dihydroxy-diphenylmethane, 4,4′-dihydroxy-diphenylethane or 4,4,′-dihydroxy-diphenylbutane.

The polycarbonate resin may be used in the form of a mixture with other transparent resins such as a polystyrene type resin, a poly methyl methacrylate type resin or a cellulose acetate type resin. At least one side of a cellulose acetate type film may be laminated with the polycarbonate resin. A method of preparing the polycarbonate type resin film usable in the invention is not specifically limited. Films prepared by any of the extrusion method, solvent-casting method and calendering method may be used. Either a uniaxially stretched film or a biaxially stretched film may be used. The solvent-casting film is preferred in view of superiority in surface fineness and optical isotropy.

The polycarbonate resin film used in the invention has a glass transition point of 110° C. or higher (preferably, 120° C. or higher) and water absorption of 0.3% or less (preferably, 0.2% or less), wherein the water content is measured after being dipped in water at 23° C. for 24 hrs.

Another preferable material is PET for the transparent support material from a viewpoint of thermal resistance, solvent resistance, machinability, mechanical strength and the like in case of coating the antireflection layer by means of various kinds of coating methods. In a particularly preferred embodiment, the antireflection layer of the invention is coated on at least one side of the transparent polymeric film described above. The antireflection film in such an embodiment may be advantageously employed as a protective film of a polarizing element, the polarizing element comprising a polarizing plate and the protective film provided on one side or both sides of the polarizing plate.

### FILM REFRACTIVE INDEX REDUCTION EXAMPLES

The following examples illustrate the preparation of the optical film in accordance with this invention.

(1) Measurement Methods and Transmission Haze Calculations

Haze Measurements

Transmission Haze was determined using a BYK Gardner Haze-Gard Plus instrument in accordance with ASTM D-1003 and JIS K-7105 methods. The haze data represent the average value taken from multiple readings made on each sample.

Size Distribution Measurements

The median diameter for the polymer particles was measured with a Horiba LA920 Low Angle Laser Light Scattering instrument.

Refractive Index Measurement

The refractive index of the bead polymer was measured by immersing the beads immersed in various Cargille refractive index liquids in 0.004 steps until they become “invisible” (indicating that the refractive index of the bead matched that of the immersion liquid). The samples were prepared and viewed at room temperature on an Olympus BX-60 microscope using transmitted bright field illumination. The field aperture is completely closed down and an orange filter (589 nm D line interference filter) is in place.

The film refractive index was measured with a Metricon 2010 Prism Coupler instrument. The samples were wiped with a lint free cloth & blown off with filtered air to remove any particulates; they were then mounted in such a way that there was a good coupling interface between the sample and the prism.

B.E.T and Density Measurements

Surface area measurements of dry polymer beads are commonly measured via nitrogen adsorption at −195° C. or via Hg intrusion at room temperature. The B.E.T. method was used to interpret the nitrogen adsorption measurements for the bead examples, using a Model NOVA-3000 Gas Adsorption Instrument manufactured by Quantachrome Instruments Inc. The sample was first degassed by a combination of heat and vacuum or heat and flowing dry nitrogen. The method then consists of a stepwise dosing of small amounts of nitrogen onto the sample, waiting for equilibrium, measuring the amount adsorbed, and then repeating the process for the next relative pressure. The amount of nitrogen adsorbed/desorbed vs. the relative pressure P/P₀ was linearly fit to calculate surface area. The units of measurement are m²/g.

The density of a known polymer bead mass was measured from the displacement of helium gas in a chamber of known volume. The ideal gas law was then applied to precisely measure the true volume of the polymer bead sample. This measured volume excludes any pores that are open to the surface and thus is a true volume.

Transmission Haze Calculations

Transmission haze calculations were used to define the upper diameter limit of the nanovoided beads in the reduced refractive index layers. This haze depends on the Mie scattering cross-section (K), the fraction (F) of the scattered light outside of the 2.5° measurement cone angle, and the volume center density (ρ_{V}). These calculations are described in further detail in the following references: G. Mie., Ann. Physik, [4] 25, 377 (1908), M. Kerker, “The Scattering of Light and Other Electromagnetic Radiation,” Chapters 3 and 4, Academic Press, New York, 1969, or C. F. Bohren. and D. R. Huffman, “Absorption and Scattering of Light by Small Particles”, Wiley, New York, 1983.

Mie theory provides a rigorous solution for light scattering by an isotropic sphere embedded in a homogeneous medium. The cross-section is determined by two dimensionless constants that describe a relative wavelength (μ) and diameter (α).
α=πD/λₘ
μ=nₚ/nₘ
where
λₘ=wavelength in the homogeneous medium.
D=measured diameter
n_{p,m}=refractive index of the isotropic sphere (p) or homogeneous medium (m).

The diameter of the isotropic spheres also determines the angular distribution of the forward scattered light intensity by the following expression that incorporates a first-order Bessel function. The angular intensity distribution is then integrated to approximate the fraction of scattered light outside of the 2.5° measurement cone.
I(Θ)=(2*J1(αΘ))²/(αΘ)²
where
I(Θ)=scattered intensity at angle Θ.
J1=first-order Bessel function.

Once the scattering cross-section (K), the fraction (F) of the scattered light outside of a 2.5° cone angle and the volume center density (ρ_{V}) are available, the transmission haze from a three dimensional array of isotropic spheres is given by the following equation.
Iₛ/Iₜ=F*(1−exp(−σΔρ_{V}l))≈K(πR²)Fρ_{V}1 (small K)
Iₛ=scattered intensity outside of a 2.5° cone angle.
Iₜ=transmitted intensity.
σ=scattering cross-section.
R=particle radius.
vf=volume fraction of beads in layer.
ρᵥ=center density in thick film volume=1*vf/(1.333*pi*(R)\hat{ }3).
l=film thickness.
F=fraction of scattered intensity outside a 2.5° cone angle.
K=scattering cross-section/geometric cross-section.
   (2) Polymer Bead Examples

Synthetic Bead #A1

To a beaker were added the following ingredients: 490 g ethylene glycol dimethacrylate, 10 g hexadecane, and 7.4 g 2,2′-azobis(2,4-dimethylvaleronitrile) (Vazo 52® from DuPont Corp.). The ingredients were stirred until all the solids were dissolved.

In a separate beaker, an aqueous phase was made by combining 1500 g distilled water with 27 g of N-Alkyl(C12-C16)-N,N-dimethyl-N-benzyl ammonium chloride, Barquat MB-50® (Lonza Inc.).

The aqueous and monomer phases were combined and then stirred with a marine prop-type agitator for 5 minutes to form a crude emulsion. The crude emulsion was passed through a Crepaco® homogenizer at 420 kg/cm². The resulting monomer droplet dispersion was placed into a three-necked round bottom flask, placed in a 50° C. constant temperature bath, and stirred at 150 revolutions/min under a positive pressure of nitrogen for 16 hours to polymerize the monomer droplets into polymeric particles, followed by four hours at 80° C. to reduce residual monomer content. After cooling to room temperature, the product was sieved through a milk filter to give 23.5% solids slurry of solid polymer particles.

Particle size, porosity, surface area and pore volume are provided in Table 2.

Synthetic Bead #A2

To a beaker were added the following ingredients: 250 g ethylene glycol dimethacrylate, 11 g hexadecane, 123 g toluene as a porogen, and 3.75 g 2,2′-azobis(2,4-dimethylvaleronitrile) (Vazo 52® from DuPont Corp.). The ingredients were stirred until all the solids were dissolved.

In a separate beaker, an aqueous phase was made by combining 1170 g distilled water with 21 g of N-Alkyl(C12-C16)-N,N-dimethyl-N-benzyl ammonium chloride, Barquat MB-50® (Lonza Inc.).

The aqueous and monomer phases were combined and then stirred with a marine prop-type agitator for 5 minutes to form a crude emulsion. The crude emulsion was passed through a Crepaco® homogenizer at 420 kg/cm². The resulting monomer droplet dispersion was placed into a three-necked round bottom flask, placed in a 50° C. constant temperature bath, and stirred at 150 revolutions/min under a positive pressure of nitrogen for 16 hours to polymerize the monomer droplets into polymeric particles, followed by four hours at 80° C. to reduce residual monomer content. After cooling to room temperature, the product was sieved through a milk filter to give 20.8% solids slurry of solid polymer particles.

Particle size, porosity, surface area and pore volume are provided in Table 2.

Synthetic Bead #A3

To a beaker were added the following ingredients: 250 g ethylene glycol dimethacrylate, 10 g hexadecane, 240 g toluene as a porogen, and 3.7 g 2,2′-azobis(2,4-dimethylvaleronitrile) (Vazo 52® from DuPont Corp.). The ingredients were stirred until all the solids were dissolved.

In a separate beaker, an aqueous phase was made by combining 1500 g distilled water with 27 g of N-Alkyl(C12-C16)-N,N-dimethyl-N-benzyl ammonium chloride, Barquat MB-50® (Lonza Inc.).

The aqueous and monomer phases were combined and then stirred with a marine prop-type agitator for 5 minutes to form a crude emulsion. The crude emulsion was passed through a Crepaco® homogenizer at 420 kg/cm². The resulting monomer droplet dispersion was placed into a three-necked round bottom flask, placed in a 50° C. constant temperature bath, and stirred at 150 revolutions/min under a positive pressure of nitrogen for 16 hours to polymerize the monomer droplets into nanovoided polymeric particles. Next, 0.6 g MAZU® antifoam agent (BASF Corp.) was added and toluene and some water were distilled off under vacuum at 60° C. to give 19% solids. After cooling to room temperature, the product was sieved through a milk filter.

Particle size, porosity, surface area and pore volume are provided in Table 2.

Synthetic Bead #A4

To a beaker were added the following ingredients: 120 g ethylene glycol dimethacrylate, 12 g hexadecane, 268 g propyl acetate as a porogen, and 1.8 g 2,2′-azobis(2,4-dimethylvaleronitrile) (Vazo 52® from DuPont Corp.). The ingredients were stirred until all the solids were dissolved.

In a separate beaker, an aqueous phase was made by combining 1200 g distilled water with 19.2 g of sodium dodecyl sulfate.

The aqueous and monomer phases were combined and then stirred with a marine prop-type agitator for 5 minutes to form a crude emulsion. The crude emulsion was passed through a Crepaco® homogenizer at 420 kg/cm². The resulting monomer droplet dispersion was placed into a three-necked round bottom flask, placed in a 50° C. constant temperature bath, and stirred at 150 revolutions/min under a positive pressure of nitrogen for 16 hours to polymerize the monomer droplets into nanovoided polymeric particles. Next, 0.6 g MAZU® antifoam agent (BASF Corp.) was added and propyl acetate and some water were distilled off under vacuum at 60° C. The dispersion was dialyzed for 3 days to remove excess surfactant and dried for two days under vacuum at 70° C.

The B.E.T. method was used with nitrogen gas at a relative pressure P/P₀=0.05-0.20 and temperature T=−195.8° C. to measure the available polymer bead surface area (perimeter and internal pores). The measured B.E.T. surface area in Table 2 increases from 42.3 m²/g for the comparative example A1 to 207.8-246.0 m²/g for the inventive examples A2-A4. In fact, the B.E.T. surface area for sample A1 is close to the perimeter area (32.8 m²/g normalized for the measured particle size distribution) measured using a Horiba LA920 Low Angle Laser Light Scattering instrument for the 0.18 μm median diameter bead.

In similar fashion, the B.E.T. measured pore volume also increases significantly from 0.311 cc/g in example A1 to 0.564-0.763 cc/g for examples A2-A4. The measured pore volume (0.311 cc/g) for the comparative example A1 is lower than the calculated interstitial volume (0.450 cc/g) of a dry bed of monodisperse beads (with a 0.18 μm diameter, D, and a 1.25 g/cc density, ρ) that could be packed in a maximally random jammed state. However, these example beads do show a finite size distribution that will pack more efficiently than the ideal monodisperse case and thereby should approach our measured result.

A maximum packing efficiency of 74% can be achieved for monodisperse beads using a face centered cubic (fcc) lattice; however, this state is highly ordered. So it is more practical to consider the maximally random jammed (MRJ) state that results in a packing efficiency at 64%; this state is also loosely termed a random close-packed structure. The mathematical definition for the MRJ state is well-described in a recent report by S. Tarquato, T. Truskett and D. Debenedetti, Phys. Rev. Lett 84, 2064 (2000). Table 1 summarizes the calculated air void in the layer based on particle to binder ratio, assuming the particle diameter distribution for the maximum pack density. Note that there is no air volume calculated for a particle loading lower than 64% (v/v), but once that value is exceeded then there is interstitial void that does not have a well-controlled size distribution and will therefore increase the transmission haze of the layer significantly.

TABLE 1
Calculated Interstitial Air Void

| Components Added | | | Resulting Layer | | |
|---|---|---|---|---|---|
| particle | binder | air | | binder | air |
| (Ed-100) | (PMMA) | dry | particle | calc | calc |
| dry (w/w) % | dry (w/w) % | (w/w) % | calc (v/v)% | (v/v)% | (v/v)% |
| 0 | 100 | 0 | 0 | 100 | 0 |
| 66 | 34 | 0 | 63.96 | 36.04 | 0 |
| 80 | 20 | 0 | 64.00 | 17.50 | 18.50 |
| 100 | 0 | 0 | 64.00 | 0 | 36.00 |

Table 2 summarizes the physical properties of the comparative and inventive polymer beads. The comparative bead (A1) made of 100% crosslinkable monomer shows a relatively low measured pore volume and surface area ratio in comparison to the inventive beads (A2, A3 and A4), in which internal pores were created intentionally using a porogen in the bead preparation. This differentiation allows internal air voids to contribute to the majority of the refractive index reduction of the layer, as opposed to interstitial air voids between the particles that are of uncontrolled size and may therefore create transmission haze.

TABLE 2
Polymer Bead Physical Properties

| | | | perimeter | BET | | Surface | |
|---|---|---|---|---|---|---|---|
| label | | D | area | pore | area | Area Ratio | ρ |
| (#) | porogen | (μm) | (m²/g) | (cc/g) | m²/g | A_{BET}/A_{calc} | (g/cc) |

Comparative

| | | | | | | | |
|---|---|---|---|---|---|---|---|
| A1 | 0% | 0.18 | 32.8 | 0.311 | 42.3 | 1.3 | 1.25 |

Inventive

| | | | | | | | |
|---|---|---|---|---|---|---|---|
| A2 | 35% | 0.17 | 33.9 | 0.647 | 207.8 | 6.1 | 1.28 |
| A3 | 50% | 0.17 | 34.2 | 0.763 | 246.0 | 7.2 | 1.27 |
| A4 | 70% | 0.16 | 36.2 | 0.564 | 223.1 | 6.1 | 1.27 |

### COATED LAYER EXAMPLES

Poly(methylmethacrylate) polymer (PMMA) was obtained at two separate weight-average molecular weights (M_{w}=350 and 996 kD/mole) from Aldrich; the typical polydispersity index (M_{w}/Mₙ) for these polymers is 2.0. To maintain a similar coating viscosity and dry laydown, the higher molecular weight PMMA was prepared at lower concentration and then coated at a higher wet laydown. For the 996 kD polymer, a 4.8% solution in n-propylacetate (nPrOAc) was coated at 10.4 cc/ft²; while for the 350 kD polymer, a 3.1-7.0% solution was coated at 7.0 cc/ft². The coating solution was applied to a 100 μm thick poly(ethylene terephthalate) substrate using a single hopper slot with a 100 μm gap moving at 1 ft (0.3 m)/min. The solutions and coating block were maintained at 25° C. and then allowed to air dry.

Eleven coating suspensions were prepared as indicated in Table 3. Zonyl FSG surfactant was added as a 1.5% (w/w) master solution in n-propylacetate (nPrOAc) to avoid coating mottle. Master solutions were also prepared at 10% (for the 350 kD) or 5% (for the 996 kD) PMMA concentrations. The dry beads were added last and the full suspension was then mixed in an ultrasonic bath for one hour at 25° C. prior to coating.

TABLE 3
Layer Formulation Summary

| | | | 5 or 10% | | 1.5% | | |
|---|---|---|---|---|---|---|---|
| Layer | Bead | Mw | PMMA | Bead | Zonvl | nPrOAc | total |
| (#) | (#) | (kD) | (g) | (g) | (g) | (g) | (g) |
| B1 | none | 350 | 31.50 | 0.00 | 0.90 | 12.60 | 45.00 |
| B2 | none | 996 | 49.50 | 0.00 | 1.04 | 1.46 | 52.00 |
| B3 | A1 | 350 | 31.50 | 1.12 | 0.90 | 11.48 | 45.00 |
| B4 | A1 | 996 | 49.50 | 0.88 | 1.04 | 0.58 | 52.00 |
| B5 | A2 | 350 | 31.50 | 0.95 | 0.90 | 11.65 | 45.00 |
| B6 | A2 | 996 | 49.50 | 0.75 | 1.04 | 0.71 | 52.00 |
| B7 | A3 | 350 | 31.50 | 0.74 | 0.90 | 11.86 | 45.00 |
| B8 | A3 | 350 | 29.00 | 1.06 | 0.90 | 14.04 | 45.00 |
| B9 | A3 | 350 | 25.50 | 1.40 | 0.90 | 17.20 | 45.00 |
| B10 | A3 | 350 | 22.00 | 1.81 | 0.90 | 20.29 | 45.00 |
| B11 | A3 | 350 | 14.00 | 2.65 | 0.90 | 27.45 | 45.00 |

Table 4 summarizes the measured transmission haze (% hz) and refractive index shift (Δn) for each of the coated layers (B1-B11) with volume fraction (vf) of the polymeric beads. The volume fraction of the solid bead A1 in layers B3-B4 was calculated to be 24.5% from measured densities of the polymer bead and the PMMA binder. Similarly, the nanovoided bead A2 was added to layers B5-B6 to give a calculated volume fraction at 22.7%, while the nanovoided bead A3 was added to layers B7-B11 to give a calculated volume fraction series from 18.6% to 66.3%.

The control examples B1 and B2 did not contain any polymeric bead to give a calculated PMMA layer thickness of 4.1 μm that agreed well with the measured thickness. The addition of beads A1, A2 or A3 to layers B3-B11 increased the calculated thickness to 5.0-5.4 μm that again agreed well with measurement.

The refractive index for layers B1 and B2 was measured at 1.4834 (350 kD) and at 1.4838 (996 kD), respectively, while the index increased (Δn=+0.0018 and +0.0031) with the incorporation of the comparative polymer bead A1 in layers B3 and B4, respectively. This increase is expected due to the higher index measured for the bead polymer (1.496) relative to the binder polymer (n=1.4834 and 1.4838). The predicted increase in refractive index for layers B3 and B4 (at Δn =+0.0037 and +0.0038) using a volume-weighted dielectric constant (where ε=n²) is also in reasonable agreement with the measured result (at Δn=+0.0018 and +0.0031).

On the other hand, the refractive index for the inventive layers B5 and B6 decreased (Δn is negative) significantly below the PMMA-only layers (B1 and B2) with the incorporation of the inventive polymer bead A2. This could only occur if the binder polymer PMMA does not completely fill the available internal nanovoids of the bead. The volume-weighted dielectric constant calculation predicts an index decrease of Δn=−0.0038 for inventive example B5 and B6 which is again in reasonable agreement with the measured result (Δn=−0.0040 and −0.0042). In this case, the index calculation used a 7.0% residual bead void volume in the inventive bead A2. In similar fashion, the film refractive index decreased further with inventive examples B7-B11 as the polymer bead A3 volume fraction increased.

In addition, the measured transmission haze for examples B3-B10 remained low (1.7-10.2%), even though the layers are ten-fold thicker (5 μm) than would be used in a single layer antireflection coating (0.5 μm). In this case, the index calculation used a 6-12% residual bead void volume in the inventive bead A2.

In contrast however, the last coated example B11 had a much higher transmission haze at 82.7%. This significant haze penalty is due to the formation of large-scale interstitial voids above the packing density (64% bead volume fraction) for the maximally random jammed (MRJ) state. Due to this haze penalty, the refractive index layer should keep the polymer bead volume fraction below 64% to avoid the undesirable increase in transmission haze in the optical film.

TABLE 4
Transmissive Haze and Antireflective Index Reduction

| | | | | |
|---|---|---|---|---|
| | | Comparative | | |
| layer | PMMA | bead | % hz | Δn |

| (#) | (Mw, kD) | (#) | (vf) | (meas) | (meas) |
|---|---|---|---|---|---|
| B1 | 350 | none | 0.0% | 0.7% | 0.0000 |
| B2 | 996 | none | 0.0% | 0.6% | 0.0000 |
| B3 | 350 | A1 | 24.5% | 3.0% | 0.0018 |
| B4 | 996 | A1 | 24.5% | 1.7% | 0.0031 |

| | | | | |
|---|---|---|---|---|
| | | Inventive | | |
| layer | PMMA | bead | % hz | Δn |

| (#) | (Mw, kD) | (#) | (vf) | (meas) | (meas) |
|---|---|---|---|---|---|
| B5 | 350 | A2 | 22.7% | 3.5% | −0.0042 |
| B6 | 996 | A2 | 22.7% | 3.3% | −0.0040 |
| B7 | 350 | A3 | 18.6% | 6.3% | −0.0025 |
| B8 | 350 | A3 | 26.6% | 6.4% | −0.0056 |
| B9 | 350 | A3 | 35.8% | 7.0% | −0.0104 |
| B10 | 350 | A3 | 46.1% | 10.2% | −0.0181 |
| B11 | 350 | A3 | 66.3% | 82.7% | −0.0543 |

The coated layers in Table 4 then demonstrate that the residual internal void within each polymer bead may be used to introduce a controlled size distribution of air voids into polymer films to reduce the layer refractive index with a minimum transmission haze penalty. There is, however, a significant haze penalty that develops with the formation of larger-scale interstitial voids above the packing density (64% bead volume fraction) for the maximally random jammed (MRJ) state.

The invention has been described in detail with particular reference to certain preferred embodiments thereof, but it will be understood that variations and modifications can be effected within the scope of the invention. The entire contents of the patents and other publications referred to in this specification are incorporated herein by reference.

1. An optical film comprising a transparent support with an antireflection layer substantially conformed in shape to the surface underlying the layer, the antireflection layer containing a binder polymer having dispersed polymer particles which are nanovoided so as to have a surface area greater than 50 m²/gm and which fill 64% or less of the layer volume.

2. The optical film of claim 1 wherein the particles have a median size less than 200 nm.

3. The optical film of claim 1 wherein the particles have a surface area of 200 m²/gm. or greater.

4. The optical film of claim 1 wherein the nanovoided polymer particles comprise a styrenic or an acrylic or a methacrylic monomer or fluorine derivatives thereof.

5. The optical film of claim 1 wherein the nanovoided polymer particles are cross-linked with a multifunctional monomer at 50 mole % or greater.

6. The optical film of claim 1 wherein the nanovoided polymer particles are cross-linked with a multifunctional monomer at 100 mole %.

7. The optical film of claim 1 wherein greater than 97 volume % of the entrapped voids are contained within the nanovoided polymer particles.

8. The optical film of claim 1 wherein the nanovoided polymer particles comprise either spherical beads or particles with an irregular shape.

9. The optical film of claim 1 wherein said antireflection layer is disposed as a single antireflection layer with a thickness below the wavelength of visible light.

10. The optical film of claim 1 wherein said antireflection layer is disposed as one or more of the layers in a multilayer film.

11. The optical film of claim 1 wherein said antireflection layer is disposed on an underlying hardcoat layer.

12. The optical film of claim 1 wherein said antireflection layer does not diffuse any residual reflected light.

13. The optical film of claim 1 wherein said antireflection layer is disposed on an underlying antiglare layer that does diffuse any residual reflected light.

14. The optical film of claim 1 wherein the nanovoided particles are incorporated in an antiglare layer.

15. The optical film of claim 1 wherein the binder polymer is selected from the group consisting of cellulose triacetate, polyethylene terephthalate, diacetyl cellulose, acetate butyrate cellulose, acetate propionate cellulose, polyethersulfone, polyacrylic-based resin, polyurethane-based resin, polyester, polycarbonate, aromatic polyamide, polyolefins, polymers derived from vinyl chloride, polyvinyl chloride, polysulfone, polyether, polynorbornene, polymethylpentene, polyether ketone and (meth)acrylonitrile.

16. The optical film of claim 1 wherein the binder polymer is selected from an acrylic or a methacrylic polymer or fluorine derivatives thereof.

17. The optical film of claim 1 wherein the binder polymer is selected from polymethyl methacrylate or fluorine derivatives thereof.

18. The optical film of claim 1 wherein the binder polymer is cross-linked.

19. The optical film of claim 1 wherein the binder polymer and nanovoided polymeric particles are cross linked to each other.

20. The optical film of claim 1 wherein said support is selected from the group consisting of cellulose triacetate, polyethylene terephthalate, cellulose diacetate, acetate butyrate cellulose, acetate propionate cellulose, polyethersulfone, polyacrylic-based resin, polyurethane-based resin, polyester, polycarbonate, aromatic polyamide, polyolefins, polymers derived from vinyl chloride, polyvinyl chloride, polysulfone, polyether, polynorbornene, polymethylpentene, polyether ketone and (meth)acrylonitrile containing polymers.

21. The optical film of claim 1 wherein said support is selected from the group of cellulose triacetate, polyethylene terephthalate, polynorbornene and polyether sulfone.

22. The optical film of claim 1 wherein said support is cellulose triacetate.

23. The optical film of claim 1 wherein additional compounds are added that include a member selected from the group consisting of antistats, surfactants, emulsifiers, coating aids, lubricants, matte particles, rheology modifiers, antifoggants, inorganic fillers, pigments, magnetic particles, UV absorbers, and biocides.

24. The optical film of claim 1 wherein an anti-fingerprint layer is disposed over the anti-reflection layer.

25. An LCD display comprising the optical film of claim 1.

26. A touch screen display comprising the optical film of claim 1.

27. An optical element or lens or window or cover plate comprising the optical film of claim 1.

28. The optical film of claim 1 wherein the voiding of said nanovoided particles is achieved by mixing a porogen with the monomers used to make said nanovoided particles, dispersing the resultant mixture in water, and polymerizing said monomers to form said nanovoided particles.

29. The optical film of claim 1 wherein the underlying surface is flat.

30. The optical film of claim 1 wherein the underlying surface is rough for glare reduction.

31. The optical film of claim 1 wherein the Surface Area Ratio is at least 3.

32. The optical film of claim 1 wherein the Surface Area Ratio is at least 5.

33. The optical film of claim 1 wherein the degree of crosslinking of the particles is at least 50 mol %.

34. The optical film of claim 1 wherein the degree of crosslinking of the particles is at least 80 mol %.

35. The optical film of claim 1 wherein the degree of crosslinking of the particles is substantially 100 mol %.
